(19) United States
(12) Patent Application Publication
(10) Pub. No.: US 2024/0010107 A1
(43) Pub. Date: Jan. 11, 2024

(54) NECK VENT PROVISION STRUCTURE FOR VENTILATED SEAT OF VEHICLE

(71) Applicant: YOUNGMIN HIGHTECH CO., LTD., Asan-si (KR)

(72) Inventor: Ki Yeong NOH, Asan-si (KR)

(21) Appl. No.: 18/035,129

(22) PCT Filed: Dec. 7, 2020
(86) PCT No.: PCT/KR2020/017765

§ 371 Date: May 3, 2023

(51) Int. Cl. B60N 2/56

(52) U.S. Cl. CPC B60N 2/5657

(57) ABSTRACT

Proposed is a neck vent provision structure for a ventilated seat of a vehicle, and, more specifically, a neck vent provision structure for a ventilated seat of a vehicle, in which a flow path of a ventilating module which blows air out of a backrest branches off to the upper end portion of the backrest so that air is blown even to the vicinity of an occupant's neck, thereby creating a pleasant occupant environment. To this end, the neck vent provision structure includes a blowing hole formed in an upper portion of the backrest, and a neck vent arranged on the ventilating module so as to guide wind from the ventilating module to the blowing hole, wherein the neck vent includes a branch duct branched off from the ventilating module, and a discharge cap arranged between the branch duct and the blowing hole.

### TECHNICAL FIELD

The present disclosure relates to a neck vent provision structure for a ventilated seat of a vehicle and, more particularly, to a neck vent provision structure for a ventilated seat of a vehicle, wherein the structure enables air to be blown even to the vicinity of an occupant's neck so as to provide a pleasant occupant environment.

### BACKGROUND ART

A seat installed in a vehicle is an essential component of the vehicle provided for seating of a driver and an occupant. Various convenience devices are installed on the seat, and various convenience devices are being developed.

For example, the angle of a backrest can be electrically adjusted, or the angle and usage state of a seat optimized for a user of the seat are stored in advance, and then a seat environment suitable for the user of a vehicle is easily provided to improve the convenience of an occupant.

In addition to this, a cooling and heating device is installed in the seat of a vehicle for the convenience of an occupant.

Of course, a vehicle is equipped with an air conditioning system to regulate a temperature inside the vehicle, but due to the material characteristics of a vehicle seat and the close contact of a user's buttocks and back with the vehicle seat, it is difficult to efficiently circulate air to the buttocks and back. Accordingly, it is required that a separate air-blowing device is provided in a seat so that a pleasant ride can be provided.

Hereinafter, a cooling and heating system installed in a seat of a vehicle will be described with reference to FIG. 1.

As illustrated in FIG. 1, a vehicle seat consists of a seat part 10 and a backrest 20.

In this case, vent holes 30 are formed in each of the seat part 10 and the backrest 20.

As illustrated in FIG. 2, the seat part 10 and the backrest 20 has a guide part 40 and guide plates 50 installed therein, wherein the guide part 40 sucks air inside a vehicle and guides the air into the seat, and guide plates 50 having a plurality of protrusions 51 guide the air sucked through the guide part 40 to the vent holes 30 of the seat.

Due to such components, while a suction fan (not shown) rotates, air inside a vehicle is sucked into the seat, and the air sucked into the seat is discharged toward an occupant's buttocks and back through the vent holes 30, thereby providing a comfortable seating environment.

However, the ventilated seat of a vehicle according to the prior art described above is configured such that wind is discharged only toward an occupant's buttocks and back, so a ventilation range for the occupant's body is limited.

That is, since wind has little effect on the neck of the body, it is difficult to provide a pleasant environment around an occupant's neck compared to the occupant's back and buttocks.

### DOCUMENT OF RELATED ART

(Patent Document) Korean Patent No. 10-1565776

### DISCLOSURE

### Technical Problem

The present disclosure has been made to solve the above problems, and is intended to propose a neck vent structure of a ventilated seat of a vehicle in which wind from a ventilating module which discharges the wind to a backrest can be branched and be discharged even through the upper part of the seat corresponding to an occupant's neck.

### Technical Solution

In order to accomplish the above objectives, the present disclosure provides a neck vent provision structure for a ventilated seat of a vehicle, the seat having vent holes formed respectively in a seat part and a backrest for an occupant and having a ventilating module provided in each of the seat part and the backrest for ventilating wind through the vent holes, the structure including: a blowing hole formed in an upper portion of the backrest, and a neck vent arranged on the ventilating module so as to guide wind from the ventilating module to the blowing hole, wherein the neck vent includes: a branch duct branched off from the ventilating module and extended toward the upper portion of the backrest; and a discharge cap arranged between the branch duct and the blowing hole for discharging wind from the branch duct off the outside of the backrest.

In this case, the ventilating module may include a backrest ventilating module and a seat-part ventilating module, wherein the backrest ventilating module may include: a back chamber having a plurality of discharge holes corresponding to the vent holes of the backrest and having an air-blowing space; and a suction blower arranged on the back chamber for sucking outside air into the air-blowing space of the back chamber.

In this case, the back chamber may be provided with a plurality of gap maintenance bosses to secure the air-blowing space, wherein the gap maintenance bosses may protrude toward opposing inner surfaces of the back chamber to prevent the opposing inner surfaces of the back chamber from being in close contact with each other such that the air-blowing space is secured even when external pressure is applied to the back chamber.

### Advantageous Effects

The neck vent structure of the ventilated seat of a vehicle according to the present disclosure has the following effects.

The neck vent is configured so that air is blown even to the vicinity of an occupant's neck, thereby providing a pleasant occupant environment inside a vehicle without being limited to an occupant's body part.

In addition, the air-blowing path of the neck vent is configured by being branched from the backrest ventilating module, thereby simplifying the configuration of the structure without a separate additional component.

Furthermore, the plurality of gap maintenance bosses is formed in the back chamber, thereby preventing the decrease of the air-blowing space of the back chamber or the clogging of the air-blowing space of the back chamber due to external pressure.

Accordingly, air blowing can be efficiently maintained even in an environment in which an occupant is seated in the seat.

### DESCRIPTION OF DRAWINGS

FIG. 1 is a perspective view illustrating a ventilated seat of a vehicle according to a prior art.

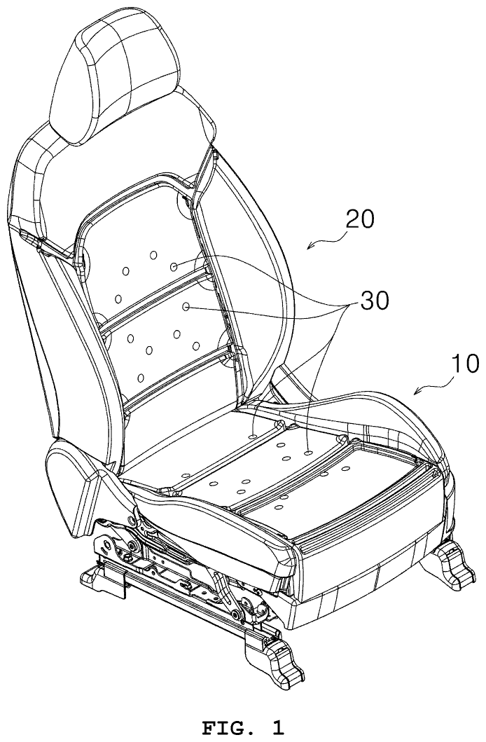

FIG. 2 is a perspective view illustrating the inside of the ventilated seat of a vehicle according to the prior art.

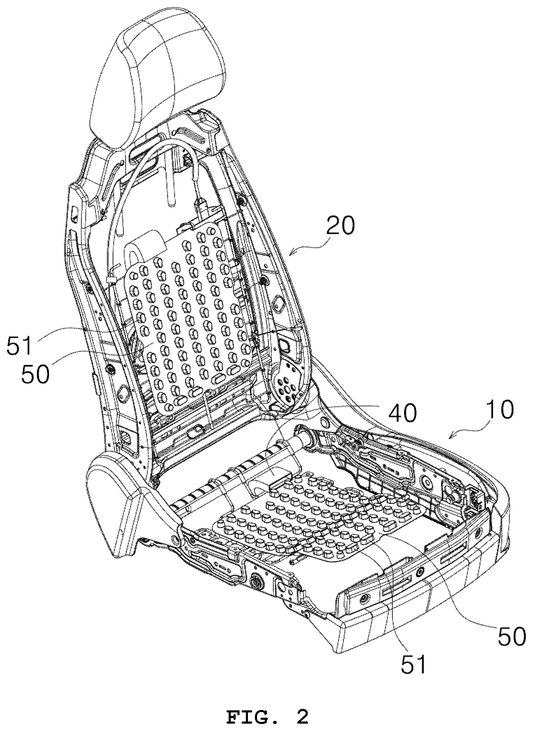

FIG. 3 is an exploded perspective view illustrating a ventilating module and a neck vent constituting a neck vent provision structure for a ventilated seat of a vehicle according to an exemplary embodiment of the present disclosure.

FIG. 4 is a side view illustrating the ventilating module and the neck vent constituting the neck vent provision structure for a ventilated seat of a vehicle according to the exemplary embodiment of the present disclosure.

FIG. 5a is a front view illustrating the ventilating module and the neck vent constituting the neck vent provision structure for a ventilated seat of a vehicle according to the exemplary embodiment of the present disclosure.

FIG. 5b is a rear view illustrating the ventilating module and the neck vent constituting the neck vent provision structure for a ventilated seat of a vehicle according to the exemplary embodiment of the present disclosure.

FIG. 6 is a cross-sectional view taken along line I-I of FIG. 5a.

FIG. 7 is a rear perspective view illustrating a partial section of the neck vent provision structure for a ventilated seat of a vehicle according to the exemplary embodiment of the present disclosure.

### BEST MODE

Terms or words used in this specification and claims are not limited to usual meaning or dictionary meaning, and should be interpreted as meanings and concepts consistent with the technical idea of the present disclosure, based on the principle that an inventor may properly define the concepts of the terms in order to explain his/her invention in the best way.

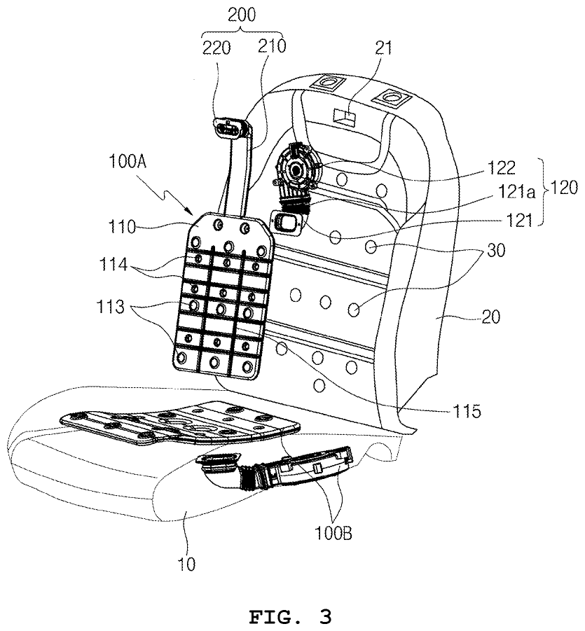

Hereinafter, a neck vent provision structure for a ventilated seat of a vehicle according to an exemplary embodiment of the present disclosure will be described with reference to FIGS. 3 to 7.

The neck vent provision structure for a ventilated seat of a vehicle allows air to be blown to the vicinity of an occupant's neck so that a pleasant environment can be provided to an occupant.

Accordingly, as illustrated in FIG. 3, a blowing hole 21 for installing the neck vent to be described later is formed in an upper part of a backrest of the ventilated seat, that is, a portion corresponding to the vicinity of an occupant's neck.

The blowing hole 21 is formed as a through hole communicating with the inside of the ventilated seat, and the shape of the blowing hole is not limited to a particular shape.

The neck vent provision structure for a ventilated seat of a vehicle includes a ventilating module 100 and the neck vent 200.

The ventilating module 100 functions to generate wind and discharge the wind to the backrest 20 and seat part 10 of the seat and is installed in each of the backrest 20 and the seat part 10.

In this case, for convenience of description, the ventilating module 100 installed in the backrest 20 is referred to as a backrest ventilating module 100A.

The backrest ventilating module 100A functions to discharge wind through vent holes 30 of the backrest 20, and to discharge wind to the upper end part of the backrest 20.

The backrest ventilating module 100A includes a back chamber 110 and a suction blower 120.

The back chamber 110 discharges outside air sucked through the suction blower 120 to each of the vent holes 30 of the backrest 20 and guides the air to the neck vent 200 to be described later.

The back chamber 110 defines an air-blowing space, and a suction hole 111 into which wind is sucked by the suction blower 120 is formed in the rear surface of the back chamber 110.

In addition, a vent hole 112 is formed in the upper end of the back chamber 110 so as to discharge wind to the neck vent 200.

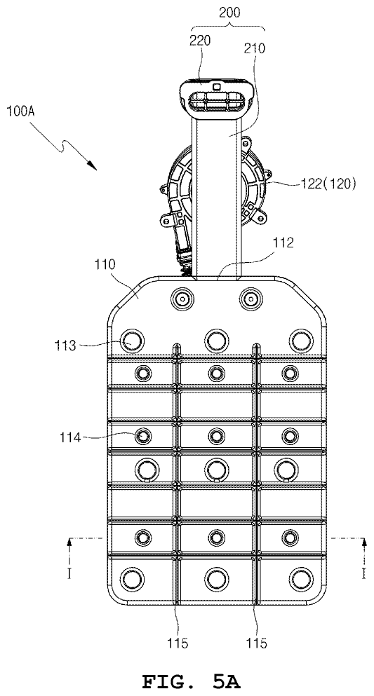

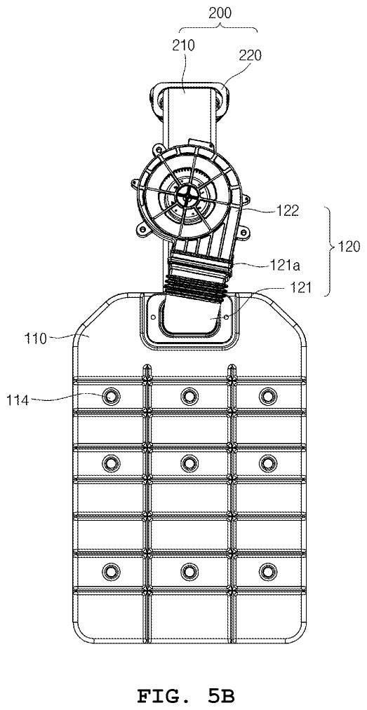

The front surface of the back chamber 110 corresponds to the vent holes 30 of the backrest 20, and as illustrated in FIG. 5a, discharge holes 113 are formed in the front surface of the back chamber 110.

Each of the discharge holes 113 is a through hole through which wind sucked through the suction hole 111 is discharged toward the vent hole 30 of the backrest 20, and allows the inside and outside of the back chamber 110 to communicate with each other.

That is, outside air introduced into the air-blowing space of the back chamber 110 is discharged through the discharge hole 113 to the vent hole 30 of the seat so that the air can be blown toward an occupant's back.

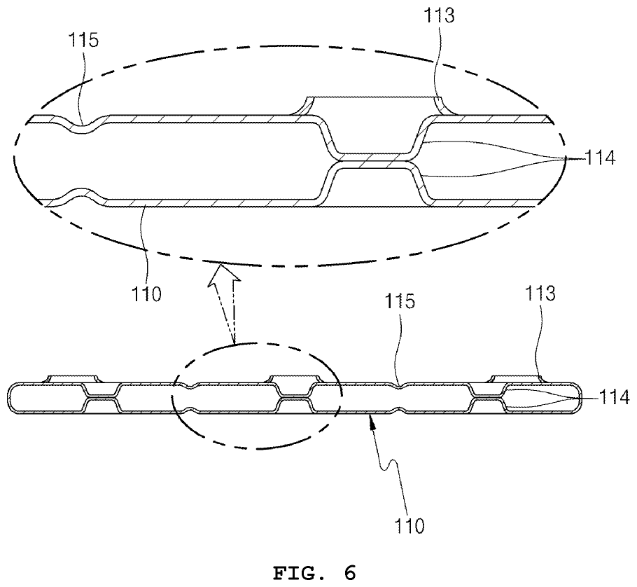

In this case, as illustrated in FIGS. 3 and 6, the edge of the discharge hole 113 is preferably formed by protruding from the front surface of the back chamber 110.

Accordingly, the edge of the discharge hole 113 is formed to be stepped from the front surface of the back chamber 110.

In addition, as illustrated in FIGS. 5a to 6, gap maintenance bosses 114 are formed in the back chamber 110.

Each of the gap maintenance bosses 114 is a component for securing the air-blowing space of the back chamber 110 even if external pressure is applied to the back chamber 110, and is formed by protruding from the inner surface of the back chamber 110.

The gap maintenance boss 114 is formed by protruding toward the inner surface of the back chamber 110, and thus through the gap maintenance boss 114, a first surface of the back chamber 110 is supported by a second surface of the back chamber 110, and accordingly, even if external pressure is applied to the back chamber 110, the back chamber 110 can be prevented from being pressed to have a reduced or clogged air-blowing space.

Meanwhile, the gap maintenance bosses 114 respectively are preferably formed by protruding from the opposing surfaces of the back chamber 110 toward the air-blowing space of the back chamber 110, and protruding parts of the gap maintenance bosses 114 are preferably held in contact with each other in the air-blowing space.

In this case, the gap maintenance boss 114 is preferably formed through a pressing process on each of the outer surfaces of the back chamber 110.

Accordingly, as illustrated in FIGS. 5a and 5b, due to the formation of the gap maintenance bosses 114, recess parts are formed in each of the outer surfaces of the back chamber 110.

Meanwhile, the material of the back chamber 110 is preferably high density polyethylene (HDPE) or elastomer.

In addition, it is preferable that lattice grooves 115 in the form of a lattice are further formed on the back chamber 110.

The lattice grooves 115 are formed for the flexible movement of the back chamber 110 and, as illustrated in FIGS. 5a and 5b, are preferably formed by partitioning the discharge hole 113 and the gap maintenance boss 114 from each other.

Due to such a configuration, even if external pressure is applied to the back chamber 110, the back chamber 110 is allowed to flexibly move through the lattice grooves 115, so a buffering effect thereof can be expected.

The suction blower 120 generates rotational force for sucking outside air and is installed in the suction hole 111 of the back chamber 110.

When the suction blower 120 generates the rotational force, outside air inside the seat is sucked through the suction hole 111 into the air-blowing space of the back chamber 110, and then escapes through the discharge hole 113 and the vent hole 112.

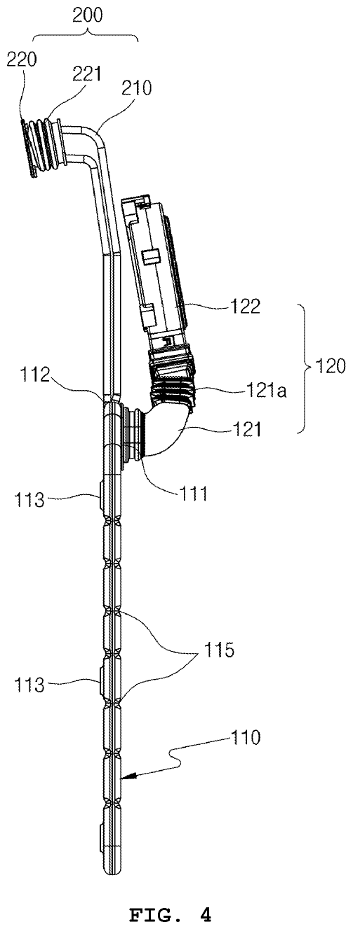

As illustrated in FIGS. 3 and 4, the suction blower 120 includes a bent pipe 121 and a suction fan 122.

The bent pipe 121 is installed in the suction hole 111 of the back chamber 110 and provides air-blowing path.

As illustrated in FIG. 4, the bent pipe 121 preferably has a bellows 121a formed thereon so that the bent pipe 121 can flexibly move without being damaged by external pressure.

The suction fan 122 generates rotational force and is installed on an end portion of the bent pipe 121.

Due to the rotational force of the suction fan 122, outside air is sucked into the back chamber 110 through the air-blowing path of the bent pipe 121.

Next, the neck vent 200 functions to guide outside air introduced into the back chamber 110 to the upper part of the backrest 20 and is installed in the vent hole 112 of the back chamber 110.

As illustrated in FIGS. 3 to 5b, the neck vent 200 includes a branch duct 210 and a discharge cap 220.

The branch duct 210 serves to guide outside air sucked into the back chamber 110 to the upper end part of the backrest 20, and is installed in the vent hole 112 of the back chamber 110.

The branch duct 210 is formed upward from the upper end of the back chamber 110 and has length (height) to correspond to the height of the blowing hole 21 formed in the backrest 20.

It is preferable that the branch duct 210 is formed upward from the back chamber 110 and then bent toward the blowing hole 21.

The discharge cap 220 functions to discharge wind guided through the branch duct 210 toward the vicinity of an occupant's neck.

To be precise, the discharge cap 220 is configured to guide wind discharged along the branch duct 210 to the outside of the seat.

The discharge cap 220 is installed on the upper end of the branch duct 210 and preferably includes a bellows 221 as illustrated in FIG. 4.

This is intended to facilitate the installation of the discharge cap 220 in the blowing hole 21 of the backrest 20, and even if there is difference between the height of the discharge cap 220 and the height of the blowing hole 21, it is possible to install the discharge cap 220 in the blowing hole 21 by flexibly changing the position of the discharge cap 220 through the bellows 221.

Hereinafter, the operation of the neck vent provision structure for a ventilated seat of a vehicle having the above configuration will be described.

As illustrated in FIG. 3, a seat-part ventilating module 100B including a back chamber and a suction blower is installed inside the seat part 10 of the seat, and air is blown through the vent holes 30 of the seat part 10 by the seat-part ventilating module 100B.

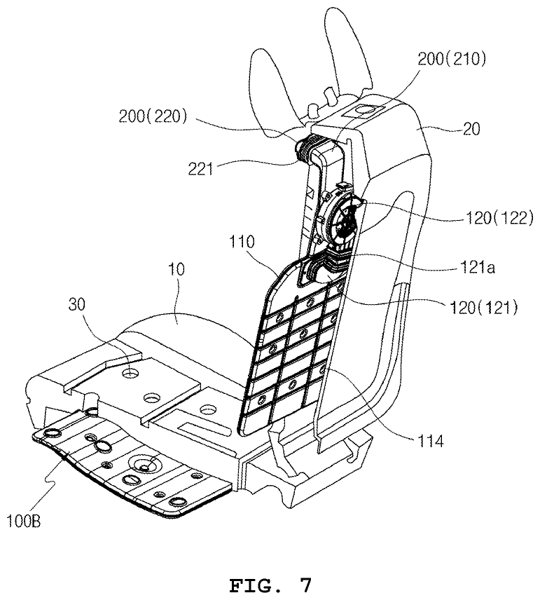

In addition, as illustrated in FIG. 7, the backrest ventilating module 100A on which the neck vent 200 is installed is installed inside the backrest 20, and the discharge cap 220 of the neck vent 200 is inserted into and coupled to the blowing hole 21.

While the neck vent 200 is installed in the seat as described above, the suction blower 120 of the backrest ventilating module 100A is operated through the air conditioning control of a vehicle.

After that, outside air inside the seat is introduced through the bent pipe 121 into the back chamber 110, and the introduced outside air, that is, wind is discharged through the discharge holes 113 and the vent hole 112 of the back chamber 110.

The wind discharged through the discharge holes 113 of the back chamber 110 is discharged through the vent holes 30 of the seat to an occupant's back, and the wind discharged through the vent hole 112 of the back chamber 110 is guided through the branch duct 210 and then is discharged through the discharge cap 220 to the vicinity of the neck of an occupant.

In addition, the wind of the seat-part ventilating module 100B is discharged toward an occupant's buttocks.

Accordingly, wind generated by the ventilating module 100 of the ventilated seat may evenly affect an occupant's entire body, and particularly, wind is blown to the vicinity of an occupant's neck so that more pleasant occupant environment can be provided.

Meanwhile, in a state in which an occupant is seated in the seat, the back chamber 110 constituting the ventilating module 100 is pressed due to the occupant's weight, and the air-blowing space is reduced, so it may be difficult that air blowing is efficiently performed, but in the back chamber 110 of the present disclosure, the gap maintenance bosses 114 support the opposite surfaces of the back chamber 110 in the air-blowing space, so the reduction of the air-blowing space due to external pressure can be minimized.

Accordingly, even if external pressure is applied to the back chamber 110, air blowing can be efficiently performed.

As described so far, in the neck vent provision structure for a ventilated seat of a vehicle according to the present disclosure, the air-blowing direction of the back chamber 110 is branched so that air can be additionally blown even to the vicinity of an occupant's neck.

In addition, even when the back chamber 110 is pressed by external pressure, the gap maintenance boss 114 can minimize the reduction of the air-blowing space and can prevent the clogging of the air-blowing space, so the efficient flow of air in the air-blowing space can be maintained.

In the above, the present disclosure has been described in detail with respect to the embodiment, but it is clear to those skilled in the art that various changes and modifications are possible within the scope of the technical idea of the present disclosure, and it is natural that these changes and modifications belong to the appended claims.

<Description of the Reference Numerals in the Drawings>

| | |
|---|---|
| 100: Ventilating module | 100A: Backrest ventilating module |
| 100B: Seat-part ventilating module | 110: Back chamber |
| 111: Suction hole | 112: Vent hole |
| 113: Discharge hole | 114: Gap maintenance boss |
| 115: Lattice groove | 120: Suction blower |
| 121: Bent pipe | 121a, 221: Bellows |
| 122: Suction fan | 200: Neck vent |
| 210: Branch duct | 220: Discharge cap |

1. A neck vent provision structure for a ventilated seat of a vehicle, the seat having vent holes formed respectively in a seat part and a backrest for an occupant and having a ventilating module provided in each of the seat part and the backrest for ventilating wind through the vent holes, the structure comprising:
a blowing hole formed in an upper portion of the backrest, and
a neck vent arranged on the ventilating module so as to guide wind from the ventilating module to the blowing hole,
wherein the neck vent comprises: a branch duct branched off from the ventilating module and extended toward the upper portion of the backrest; and a discharge cap arranged between the branch duct and the blowing hole for discharging wind from the branch duct off the outside of the backrest.

2. The structure of claim 1, wherein the ventilating module comprises a backrest ventilating module and a seat-part ventilating module,
wherein the backrest ventilating module comprises:
a back chamber having a plurality of discharge holes corresponding to the vent holes of the backrest and having an air-blowing space; and
a suction blower arranged on the back chamber for sucking outside air into the air-blowing space of the back chamber.

3. The structure of claim 2, wherein the back chamber is provided with a plurality of gap maintenance bosses to secure the air-blowing space,
wherein the gap maintenance bosses protrude toward opposing inner surfaces of the back chamber to prevent the opposing inner surfaces of the back chamber from being in close contact with each other such that the air-blowing space is secured even when external pressure is applied to the back chamber.
